(19) United States
(12) Patent Application Publication
(10) Pub. No.: US 2005/0134523 A1
(43) Pub. Date: Jun. 23, 2005

(54) Creating an encrypted channel to a wireless video display

(75) Inventors: David Carroll Challener, Raleigh, NC (US); Clain Harmer Anderson, Chapel Hill, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/738,182

(22) Filed: Dec. 17, 2003

(51) Int. Cl. G09G 5/00; G09G 3/00

(52) U.S. Cl. 345/1.1

(57) ABSTRACT

A system for creating a secure wireless channel between a laptop computer and a video projector. The system allows a person, or presenter, to send presentation information wirelessly without having to worry about unwanted eavesdroppers receiving the presentation information. Prior to the presentation, the projector generates a random number and projects the number on a screen. The presenter types the random number into his computer and an encryption program within the computer uses the random number to create a temporary session key. Advantageously, the random number is never transmitted wirelessly. The session key is then used to encrypt the presentation information before the information is wirelessly transmitted to the projector. The projector receives the information and uses the same random number to decrypt the presentation information. After decryption, the presentation information is projected on a screen for presentation to the audience.

### BACKGROUND OF THE INVENTION

The present invention relates generally to the field of wireless video projectors and more specifically to a method for providing a secure wireless channel to a video projector.

Wireless video projectors are projectors that receive the information that they display wirelessly from a transmitter. The video information is broadcast from the transmitter and received by a receiver that is electrically connected to the projector. An unfortunate consequence of broadcasting any information wirelessly is that unwanted eavesdroppers with an appropriate receiver can also receive the information. In the case of wireless video information that is transmitted via radio waves, an unwanted eavesdropper does not even have to be in the same building as the transmitter to receive the video information. When a presentation is made, with the aid of a projector, and the presentation includes information that is to be kept secret, it is important that a secure communication channel be established. One attempt at preventing the unauthorized reception of transmissions has been to use public/private encryption keys.

Public/private key encryption is an encryption scheme that utilizes a public key and a private key that are mathematically related. Based on a public-key/private-key pair, digital messages can be encrypted by either of the keys and decrypted by the other. Public keys are recorded in a public directory and the private keys are privately retained. The sender of digital information can go to a public-key directory to find the receiver's public key. The sender then encrypts the message with the receiver's public key, and conveys the encrypted message to the receiver. The receiver then uses his private key to decrypt the message. Such a public/private key scheme resolves the problem of creating a secure communication channel in a wired environment where the recipient is a fixed entity, such as a server. However, when the recipient is a moveable entity, such as a video projector, and transmissions are broadcast in a wireless environment, an alternative method for creating a secure communication channel is necessary.

A beneficial feature of digital video projectors, that is lost if public/private keys are used, is the fungible nature of projectors. All digital video projectors are able to perform the same basic functions. In a company with multiple digital video projectors, it shouldn't matter which projector is used in any one of the multiple presentations that are made by the company each week, or each day. A company employee in charge of setting up a presentation wants to be able to grab any projector that he can get his hands on and not have to worry about finding a specific projector. What is needed in the field is a wireless video projector that can be used by unrelated parties in multiple presentations, wherein the projector provides a secure communication channel for each of the presentations.

### SUMMARY OF THE INVENTION

A system for providing a secure wireless channel for transmitting presentation information from a laptop computer to a video projector. The video projector includes a random number generator, a receiver for receiving wireless information, and a decryption program for decrypting received information. A random number, generated within the projector, is projected on a screen prior to a video presentation. A keyboard is used to enter the random number into the computer. An encryption program within the computer uses the random number to create a session key and then uses the session key to encrypt the presentation information. The computer includes a transmitter that is used to transmit the encrypted presentation information wirelessly. The projector receives the encrypted information and uses the random number to decrypt the received information. The presentation information is thereafter sent to display circuitry for projection onto the screen.

The transmitted information may include multiple types of information including text, chart, photograph, drawing and video information. In the preferred embodiment, the computer includes speakers that are used to broadcast any audio information associated with the presentation

It is an object of the present invention to provide a wireless video presentation system that prevents unwanted electronic eavesdropping.

It is a further object of the present invention to provide a system wherein a new encryption key is created and used for each presentation, and wherein information that is required to create an encryption key is never transmitted wirelessly.

### BRIEF DESCRIPTION OF THE DRAWINGS

The invention of the present application will now be described in more detail with reference to the accompanying drawings, given only by way of example, in which:

FIG. 1 is a schematic diagram of the preferred embodiment;

FIG. 2 shows block diagrams of an exemplary personal computer and projector; and,

FIG. 3 is a flow chart of steps in the present method.

### DETAILED DESCRIPTION OF THE INVENTION

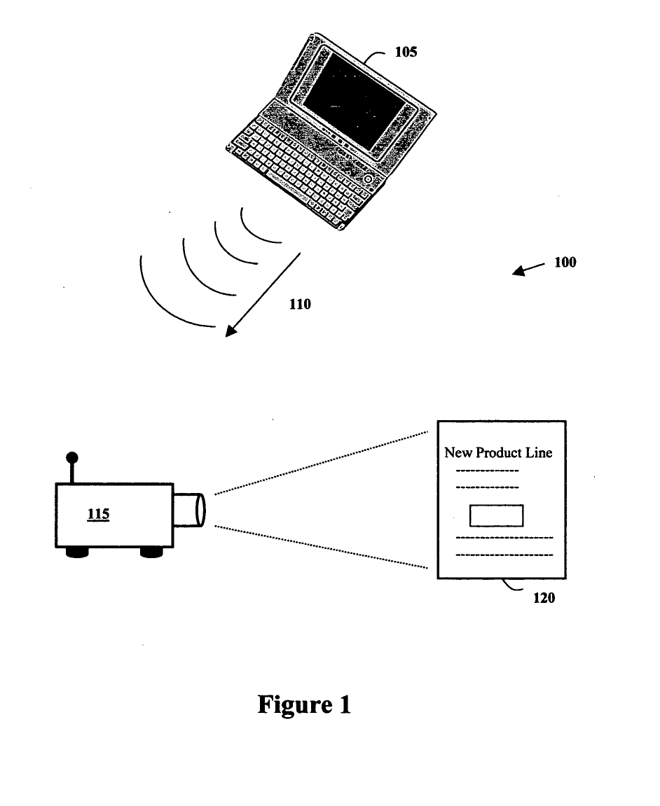

The present system 100 allows confidential information to be securely transmitted from a laptop computer to a video projector, wirelessly. The present method prevents anyone from outside of a room in which a presentation is taking place from being able to decode the transmitted information. Referring to FIG. 1, a laptop computer 105 is used in the preferred embodiment for encrypting and wirelessly transmitting 110 the presentation information. Of course, other computers and computing devices with similar components may be used in place of computer 105 in the present method. Computer 105 includes a wireless transmitter for sending wireless communication signals, such as radio and infrared waves, to a nearby receiver. The computer 105 is used by a person, or presenter, to give a presentation to any number of people within a room of any size. The presenter's presentation information is stored within a storage device of the computer 105. Prior to the actual presentation, a number of steps are taken to create the secure wireless channel. First, a signal is sent from the computer 105 to the projector 115, or alternatively a button is pushed on the projector, that causes the projector 115 to generate a random number and then project the number on a screen 120. The presenter reads the projected number and enters the number into the keyboard of the computer 105. An encryption program within the computer 105 uses the random number to create a session key that is then used to encrypt the presentation information stored within the computer. At this point the security of the presentation's wireless transmission, or transmissions, are assured. Of course, steps would have to be taken to insure that no one from outside of the room is able to read the screen, such as closing blinds in the room or projecting the number on a temporary screen, such as a sheet of paper held close to the projector. Of course, if confidential information is to be displayed, then steps would automatically be taken to insure that unwanted persons would not be able to see the projection screen.

When the presenter is ready to begin the presentation, he clicks on a “start” button on the screen of the computer 105, in the preferred embodiment, and the presentation information is transmitted wirelessly 110 to the projector 115. The concept is that while everyone in the room may have the opportunity to see the random number that is generated and projected by the projector, these are the same people to which the presentation is to be given. Thus, none of the people with the potential ability to decode the wireless transmissions are unwanted eavesdroppers. Quite to the contrary, the only people given the opportunity to decode the transmission are the exact people that the presenter wants to fully understand and appreciate the wireless transmissions. The projector 115 includes a decryption program that uses the projected random number to create a session key that is related to the session key created within the computer 105. The decryption program of the projector 115 then uses the session key created within the projector to decrypt the wireless information that was received from the computer 105. After decryption, the presentation information is sent to the display circuitry within the projector 115 for projection onto the screen 120. In one embodiment, only one screen of information of sent to the projector 115 at a time and the computer 105 is used to control advancing through the presentation. In an alternative embodiment, the projector has a sufficient amount of memory to receive the entire presentation in one transmission and the handheld remote control unit of the projector is used to advance through the presentation.

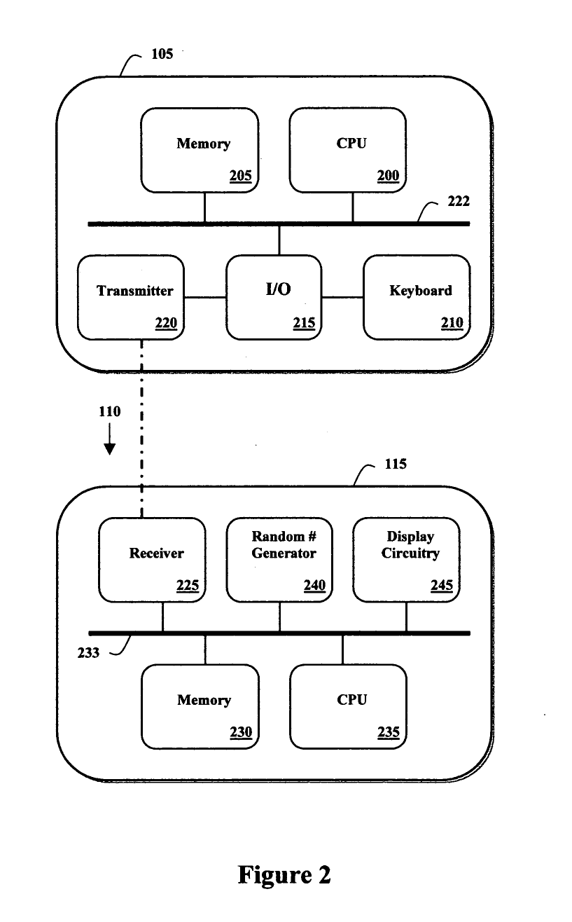

FIG. 2 is a block diagram of the computer 105 and the projector 115. For clarity purposes, only the components of interest are illustrated in the block diagram of FIG. 2. The activities of the computer 105 are controlled by CPU 200, which receives information from, and sends information to, memory 205. The memory 205 includes an encryption program and the presentation information that will eventually be projected on the screen during the actual presentation. The presentation may be a multimedia presentation that includes multiple types of data, such as pictures and text. In the preferred embodiment, audio files associated with the presentation are played over speakers connected to the computer 105. However, audio files could be wirelessly transmitted to a projector with speakers, or another speaker system, in other embodiments. The encryption program of the memory 205 serves two main functions. First, in response to receiving the random number from a user, the encryption program creates a temporary session key that can be used to encrypt any digital information. Second, the encryption program uses the session key to encrypt the presentation information, which makes the presentation information ready for secure wireless transmission.

All of the major components of computer 105 are connected to a communications bus 222, which provides parallel transmission of data and instruction information within the computer 105. Input/Output (I/O) controller 215 receives data from keyboard 210 and forwards this information to appropriate software modules within the computer 105. I/O controller 215 also sends information that is to be transmitted wirelessly to transmitter 220. The information may be transmitted through any of the well-known wireless transmission methods. In the preferred embodiment, the transmitter 220 includes an antenna and the digital information is imprinted on radio waves 110 that oscillate from the antenna. The projector 115 includes a receiver 225 that receives the wireless transmissions 110, extracts the digital information stored therein, and sends the digital information to the memory 230 of the projector. The memory 230 of the projector 115 also holds a decryption program that under the control of CPU 235 is used to decrypt the received information. The decryption program uses the random number that was generated by random number generator 240, and projected by display circuitry 245, to decrypt the received information. The decrypted presentation information is then held within memory 230 until it is sent to the display circuitry 245 for projection onto the screen. The display circuitry includes a light bulb, or lamp, of sufficient wattage to project an image at least as far as the length of the room in which the presentation is held.

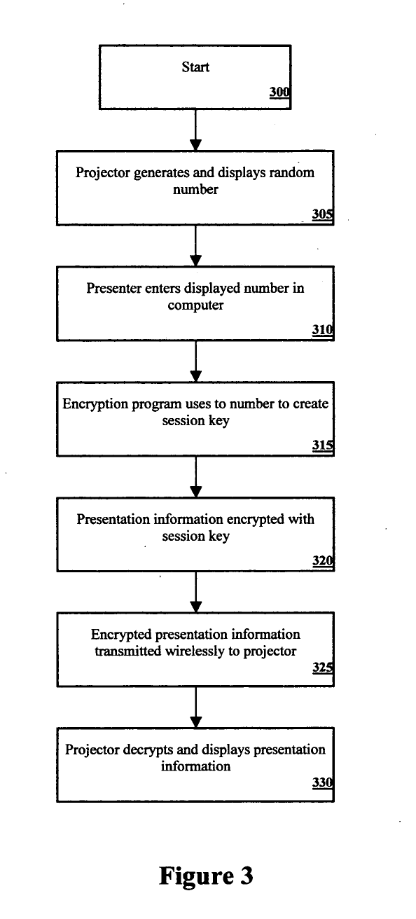

FIG. 3 is a flow chart of the present method. In step 300, a “start” signal is either sent to the projector from the computer, or a button is pushed on the projector that generates a “start” signal within the projector. In step 305, the projector reacts to the “start” signal by generating and displaying a random number. The random number may be projected on to the main screen on which the presentation is to be displayed, or alternatively the number can be displayed on a second screen that is not as big or far away from the projector as the main screen. In step 310, the presenter enters the random number into the keyboard of his computer. In step 315, the encryption program of the computer uses the random number to create a temporary session key that can be used to reversibly encrypt any digital information. In step 320, the encryption program encrypts the presentation information with the session key that was created in step 315. In step 325, the encrypted presentation information is wirelessly transmitted from the computer to the projector. In step 330, the projector uses the random number from step 305 to decrypt the presentation information. After decryption, the projector displays the presentation information on the main screen for viewing by the audience.

The foregoing description of the specific embodiments will so fully reveal the general nature of the invention that others can, by applying current knowledge, readily modify and/or adapt for various applications such specific embodiments without departing from the generic concept. For example the projector could generate a random set of alphanumeric characters instead of a random number. Further, the computer and projector could be equipped with transceivers so the projector could also send signals to the computer, such as flow control signals. Therefore, such adaptations and modifications should and are intended to be comprehended within the meaning and range of equivalents of the disclosed embodiments. It is to be understood that the phraseology of terminology employed herein is for the purpose of description and not of limitation.

1. A wireless projector system that provides a secure wireless channel for transmitting information, the system comprising:
a video projector, wherein the projector includes a random number generator for generating a random number that is projected prior to a video display session, a receiver for receiving information that has been transmitted wirelessly, and a decryption program for decrypting received information, wherein the decryption program uses the random number to decrypt the received information;
a computer, wherein the computer includes an encryption program for encrypting information and a transmitter for wirelessly transmitting information, wherein the encryption program uses the random number to create a session key and then encrypts a presentation information with the session key, and wherein the transmitter wirelessly transmits the encrypted presentation information to the video projector.

2. The system of claim 1, wherein the system further comprises a projection screen on which the random number and the presentation information are displayed.

3. The system of claim 1, wherein the presentation information includes one or more types of information including text, chart, photograph, drawing and video information.

4. The system of claim 1, wherein the computer includes speakers that are used to broadcast any audio information associated with the presentation

5. The system of claim 1, wherein the computer is a laptop computer.

6. The system of claim 1, wherein the random number is entered into a keyboard of the computer by a user.

7. The system of claim 1, wherein the projector includes a random character generator and a set of random alphanumeric characters are generated and projected by the projector, and wherein the alphanumeric characters are used by the computer to encrypt the presentation information and by the projector to decrypt the received information.

8. The system of claim 1, wherein the computer transmits the encrypted presentation information in one transmission.

9. The system of claim 1, wherein the computer transmits the encrypted presentation information in multiple transmissions.

10. The system of claim 1, wherein the receiver of the projector is a transceiver, the transmitter of the computer is a second transceiver, and the projector is able to send signals to the computer, including flow control signals.

11. A method for creating a secure wireless channel between a computer and a projector, comprising the steps of:
generating a random number by the projector, wherein the projector includes a random number generator, for generating the random number, and a wireless receiver;
projecting the random number, by the projector, on a projection screen;
entering the random number into a keyboard of the computer;
creating a session key, by an encryption program within the computer, wherein the encryption program uses the random number to create the session key;
using the session key to encrypt a presentation information to create encrypted information; and,
wirelessly transmitting the encrypted information from a transmitter of the computer to the projector.

12. The method of claim 11, further comprising the steps of:
receiving the encrypted information by the projector; and,
decrypting the encrypted information by a decryption program within the projector to re-create the presentation information, wherein the random number is used by the decryption program to decrypt the encrypted information.

13. The method of claim 12, further comprising the step of:
projecting the presentation information on the projection screen.

14. The method of claim 11, wherein the presentation information includes one or more types of information including text, chart, photograph, drawing and video information.

15. The method of claim 13, wherein the computer includes at least one speaker, and further comprising the step of:
broadcasting any audio information associated with the presentation through the speakers.

16. The method of claim 11, wherein the computer is a laptop computer.

17. The method of claim 11, wherein projector includes a random alphanumeric character generator and a set of random alphanumeric characters are generated and projected by the projector, and further wherein the set of random alphanumeric characters are used by the computer to encrypt the presentation information and by the projector to decrypt the received information.

18. The method of claim 11, wherein the computer transmits the encrypted presentation information in one transmission.

19. The method of claim 11, wherein the computer transmits the encrypted presentation information in multiple transmissions.

20. The method of claim 12, wherein the receiver of the projector is a transceiver, the transmitter of the computer is another transceiver, and the projector is able to send signals to the computer, including flow control signals.
